(19) United States
(12) Patent Application Publication
(10) Pub. No.: US 2015/0239713 A1
(43) Pub. Date: Aug. 27, 2015

(54) Hydraulic Grapple

(71) Applicant: A WARD ATTACHMENTS LIMITED, Hamilton (NZ)

(72) Inventor: Simon Robert Ward, Auckland (NZ)

(73) Assignee: A Ward Attachments Limited, Auckland (NZ)

(21) Appl. No.: 14/431,297

(22) PCT Filed: Sep. 25, 2013
(86) PCT No.: PCT/NZ2013/000178

§ 371 Date: Mar. 25, 2015

(30) Foreign Application Priority Data
Sep. 25, 2012 (NZ) 602620

(51) Int. Cl. B66C 3/04; B66C 3/14; B66C 3/00; B66C 3/16

(52) U.S. Cl. CPC B66C 3/04; B66C 3/16; B66C 3/14; B66C 3/005

(57) ABSTRACT

The invention relates to a grapple assembly in which a single actuator is used to operate the arms of the grapple but each arm is able to at least partly open and/or close independently of the other arms. A grapple assembly comprises an elongate core comprising a linear actuator; means for connecting the first end of the elongate core to a grapple hoist; a plurality of grapple arms connected to the second end of the elongate core by a pivotal connection oriented substantially perpendicularly to the elongate core; a plurality of elastically deformable connectors, each connector having coupled directly or indirectly to a connection region of the elongate core and coupled to one of the grapple arms at a point on the respective grapple arm spaced apart from the pivotal connection of the respective grapple arm to the elongate core, wherein the linear actuator is able to be actuated to move the connection region of the elongate core relative to the second end of the elongate core to open and/or close the plurality of grapple arms, and wherein the elastically deformable connectors permit each grapple arm to at least partly open and/or close independently of the other grapple arms upon exertion of an external force on the respective grapple arm.

### FIELD OF INVENTION

The present invention generally relates to the field of grapples and particularly hydraulic grapples used to pick up objects or materials.

### BACKGROUND TO THE INVENTION

A grapple is a hook or claw mounted on an apparatus that is used to pick up or hold objects or materials. Grapples commonly comprise a number of opposed hooks or claws that can pivot on their mounting so that, when the grapple is closed, the ends of the hooks or claws come together. The claws can therefore be closed to pick up objects or materials such as bulk materials, scrap materials, particulate matter and the like, as well as larger objects such as crates, vehicles, etc.

Grapples may be mounted on vehicles such as trucks or cranes or they may be mounted to a permanent fixture such as a rigging.

Many grapples are hydraulically powered by virtue of hydraulic cylinders, each connecting a claw to a central shaft. Actuation of the cylinders causes the claws to open and close. The hydraulic cylinders are usually connected to the same hydraulic fluid source by means of a distribution system comprising a number of hoses. The distribution system may allow the cylinders to be controlled together or separately.

One advantage of actuating the claws by means of separate hydraulic cylinders is that unevenly shaped objects can be picked up by the grapple because each hydraulic cylinder can compress by the extent required by the side of the object it contacts.

However, a disadvantage with such grapples is that numerous hoses are required to feed the hydraulic fluid between the reservoir and the cylinders. These hoses often project out of the grapple in a disordered way and they are susceptible to being damaged, particularly if they come into contact with the ground or sharp objects. Damage to the hoses results in the expense of time and cost to fix them. Hydraulic fluid may also leak, which can cause contamination or at least take time and cost to clean up.

In some grapples the hoses are protected by guards or covers but these add componentry and therefore complexity and cost to the manufacture of those grapples. In addition, the guards or covers may not be totally effective at preventing damage to the hoses.

Another type of grapple comprises a central actuator that is cable-actuated. A cable pulls a boss upwards and, since the boss is linked to the grapple claws, the grapple opens. The claws may close under gravity or by means of another cable. This type of grapple is used in cable cranes and avoids the need for hydraulic systems. However, this type of grapple is generally only useful for picking up particulate or small-object bulk materials and not unevenly shaped objects because the claws cannot be closed by different amounts.

Many existing types of grapple are prone to damage if the tips of the claws impact the ground. This impact may either damage the claws themselves or may be transmitted through the claws and cause damage to the actuation mechanism. Some existing grapples have replaceable claw tips but replacing claw tips takes time and the replacement tips themselves are an additional cost and storage burden.

### OBJECT OF THE INVENTION

It is an object of the invention to provide an improved grapple assembly. Alternatively, it is an object to provide a grapple assembly that addresses one or more of the disadvantages of the prior art, such as those described above. Alternatively, it is an object of the invention to at least provide the public with a useful choice.

### SUMMARY OF THE INVENTION

According to a first aspect of the invention, there is provided a grapple assembly comprising:
an elongate member comprising an elongate cavity therein and a plurality of longitudinal channels between the cavity and an elongate outer surface;
means for connecting a first end of the elongate member to a grapple hoist;
a cylinder actuator mounted inside the elongate member and able to extend longitudinally therein;
a plurality of grapple arms, each grapple arm being connected to a second end of the elongate member by a pivotal connection oriented substantially perpendicularly to the elongate member; and
a plurality of connecting rods, each connecting rod having a first end pivotally coupled to the cylinder actuator and a second end pivotally coupled to one of the grapple arms at a point on the respective grapple arm spaced apart from the pivotal connection of the respective grapple arm to the elongate member, each connecting rod being directly or indirectly coupled to the cylinder actuator through one of the longitudinal channels of the elongate member.

Preferably, each grapple arm is able to at least partly open or close independently of the other grapple arms upon exertion of an external force on the respective grapple arm.

It will be understood that an “external” force in this context is a force exerted from outside the grapple assembly. Such a force may be exerted on one of the grapple arms in a number of ways including, but not limited to, impact of the grapple arm on another object or the ground. Equivalently, closing the grapple arms around an asymmetric object(s) may cause a different force to be exerted on one of the grapple arms compared to another grapple arm. If each grapple arm is able to open or close independently of the other grapple arms then a grapple arm attempting to close around a larger part of an object can remain in a position of maximum closure around the larger part while another grapple arm continues to close towards a smaller part of the object.

In some embodiments of the invention, each connecting rod is adapted to contract upon exertion of the force on the corresponding grapple arm.

Preferably, each connecting rod comprises damping means. More preferably, each connecting rod comprises resilient means acting to oppose contraction of the connecting rod. For example, the resilient means may comprise one or more springs.

In a preferred embodiment, each connecting rod comprises two rod sections engaged together and able to move longitudinally relative to each other, the two rod sections interacting by means of one or more springs such that longitudinal contraction of the connecting rod is resiliently opposed. For example, the spring(s) may be positioned between the rod sections.

In preferred embodiments, the cylinder actuator comprises a piston and a barrel, the piston being connected to the elongate member proximate the first end thereof, and the plurality of connecting rods being connected to the barrel.

More preferably, the cylinder actuator comprises a hydraulic cylinder.

Preferably, the grapple assembly comprises means for connecting the cylinder actuator to a fluid pump.

In some embodiments, the first end of each connecting rod is pivotally coupled to the cylinder actuator by means of a fin connected to the cylinder actuator, the fin extending through one of the longitudinal channels in the elongate member.

Preferably, the means for connecting the first end of the elongate member to the grapple hoist comprises a rotatable connection means, wherein the grapple assembly can rotate relative to the hoisting means.

More preferably, the means for connecting the cylinder actuator to the fluid pump comprises one or more fluid conduits adapted to rotatably connect to one or more hoist fluid conduits such that the grapple assembly can rotate relative to the hoisting means.

According to a second aspect of the invention, there is provided a grapple assembly comprising:

an elongate member;
means for connecting a first end of the elongate member to a grapple hoist;
a linear actuator having a moveable member engaging the elongate member, the moveable member able to move longitudinally with respect to the elongate member;
a plurality of grapple arms, each grapple arm connected to a second end of the elongate member by a pivotal connection oriented substantially perpendicularly to the elongate member; and
a plurality of connecting rods, each connecting rod having a first end pivotally coupled to the linear actuator and a second end pivotally coupled to one of the grapple arms at a point on the respective grapple arm spaced apart from the pivotal connection of the respective grapple arm to the elongate member,
wherein each grapple arm is able to at least partly open or close independently of the other grapple arms upon exertion of an external force on the respective grapple arm.

In some embodiments of the invention, each connecting rod is adapted to contract upon exertion of the force on the corresponding grapple arm.

Preferably, each connecting rod comprises damping means. More preferably, each connecting rod comprises resilient means acting to oppose contraction of the connecting rod. For example, the resilient means may comprise one or more springs.

In a preferred embodiment, each connecting rod comprises two rod sections engaged together and able to move longitudinally relative to each other, the two rod sections interacting by means of one or more springs such that longitudinal contraction of the connecting rod is resiliently opposed. For example, the spring(s) may be positioned between the rod sections.

Preferably, the elongate member comprises an elongate cavity therein and a plurality of longitudinal channels between the cavity and an elongate outer surface;
the linear actuator comprises a cylinder actuator mounted inside the elongate member and able to extend longitudinally therein; and
wherein each connecting rod is directly or indirectly coupled to the cylinder actuator through one of the longitudinal channels of the elongate member.

In some embodiments, the first end of each connecting rod is pivotally coupled to the cylinder actuator by means of a fin connected to the cylinder actuator, the fin extending through one of the longitudinal channels in the elongate member.

In preferred embodiments, the cylinder actuator comprises a piston and a barrel, the piston being connected to the elongate member proximate the first end thereof, and the plurality of connecting rods being connected to the barrel.

More preferably, the cylinder actuator comprises a hydraulic cylinder.

Preferably, the grapple assembly comprises means for connecting the cylinder actuator to a fluid pump.

Preferably, the means for connecting the first end of the elongate member to the grapple hoist comprises a rotatable connection means, wherein the grapple assembly can rotate relative to the hoisting means.

More preferably, the means for connecting the cylinder actuator to the fluid pump comprises one or more fluid conduits adapted to rotatably connect to one or more hoist fluid conduits such that the grapple assembly can rotate relative to the hoisting means.

According to a third aspect of the invention, there is provided a grapple assembly comprising:
an elongate member;
means for connecting a first end of the elongate member to a grapple hoist;
a linear actuator having a moveable member engaging the elongate member, the moveable member able to move longitudinally with respect to the elongate member;
a plurality of grapple arms, each grapple arm connected to a second end of the elongate member by a pivotal connection oriented substantially perpendicularly to the elongate member; and
a plurality of elastic means, each elastic means connecting one of the grapple arms to the moveable member of the linear actuator such that each grapple arm is able to at least partly open or close independently of the other grapple arms upon exertion of an external force on the respective grapple arm.

In some embodiments, the grapple assembly comprises a plurality of connecting rods, each connecting rod having a first end pivotally coupled to the linear actuator and a second end pivotally coupled to one of the grapple arms at a point on the respective grapple arm spaced apart from the pivotal connection of the respective grapple arm to the elongate member, wherein each connecting rod comprises one of the elastic means.

In alternative embodiments of the invention, the moveable member of the linear actuator is mounted inside an elongate cavity in the elongate member and each grapple arm comprises a cantilevered end extending from the respective pivotal connection into or into line with the elongate cavity in the elongate member, and each elastic means connects the cantilevered part of one of the grapple arms with the moveable member of the linear actuator.

Preferably, the linear actuator is a cylinder actuator, for example a hydraulic cylinder.

Preferably, the elastic means each comprise at least one spring.

According to another aspect of the invention, there is provided a grapple assembly comprising:
an elongate core having a first end and a second end, and comprising a linear actuator;
means for connecting the first end of the elongate core to a grapple hoist;
a plurality of grapple arms, each grapple arm connected to the second end of the elongate core by a pivotal connection oriented substantially perpendicularly to the elongate core;
a plurality of elastically deformable connectors, each connector having a first end coupled directly or indirectly to a connection region of the elongate core, and a second end coupled to one of the grapple arms at a point on the respective grapple arm spaced apart from the pivotal connection of the respective grapple arm to the elongate core,
wherein the linear actuator is able to be actuated to move the connection region of the elongate core relative to the second end of the elongate core to open and/or close the plurality of grapple arms, and
wherein the elastically deformable connectors permit each grapple arm to at least partly open and/or close independently of the other grapple arms upon exertion of an external force on the respective grapple arm.

In some embodiments of the invention, each elastically deformable connector is adapted to contract upon exertion of the force on the corresponding grapple arm.

Preferably, each elastically deformable connector comprises damping means. More preferably, each connecting rod comprises resilient means acting to oppose contraction of the connecting rod. For example, the resilient means may comprise one or more springs.

In one embodiment, each elastically deformable connector comprises two rod sections engaged together and able to move longitudinally relative to each other, the two rod sections interacting by means of one or more springs such that longitudinal contraction of the connector is resiliently opposed. For example, the spring(s) may be positioned between the rod sections.

Alternatively, the elastically deformable connectors each comprise first and second rods having ends connected together by means of a torsion spring. In one embodiment of the invention, a rubber torsion spring is used.

In some embodiments, the first end of each elastically deformable connector is pivotally coupled to the connection region of the elongate core by means of a fin connected to the connection region.

In one embodiment of the invention, each grapple arm is directly or indirectly connected to a moveable member of the linear actuator. More preferably, the first end of each elastically deformable connector is connected to a fixed part of the elongate core.

Preferably, the elongate core comprises an first elongate member with an elongate cavity therein, the elongate cavity having an opening at the second end of the elongate core, the linear actuator is mounted inside the first elongate member with the moveable member thereof extending out of the opening at the second end of the first elongate member and able to move longitudinally with respect to the first elongate member.

Preferably, the elongate core comprises a second elongate member in telescoping relationship with the first elongate member, the moveable member of the linear actuator being mounted inside the second elongate member and the plurality of grapple arms being connected to an outer portion of the second elongate member.

In an alternative embodiment of the invention, the first end of each elastically deformable connector is directly or indirectly connected to a moveable member of the linear actuator. More preferably, each grapple arm is connected to a fixed part of the elongate core.

Preferably, the elongate core comprises an elongate member comprising an elongate cavity therein and a plurality of longitudinal channels between the cavity and an elongate outer surface, the linear actuator is mounted inside the elongate member and the moveable member thereof is able to move longitudinally therein, and the plurality of elastically deformable connectors are each coupled to the moveable member through one of the longitudinal channels of the elongate member.

Preferably, each fin couples one of the elastically deformable connectors to the moveable member and extends through one of the longitudinal channels in the elongate member.

In another alternative embodiment of the invention, the moveable member of the linear actuator is mounted inside an elongate cavity in the elongate core and each grapple arm comprises a cantilevered end extending from the respective pivotal connection into or into line with the elongate cavity in the elongate core, and each elastically deformable connector connects the cantilevered part of one of the grapple arms with the moveable member of the linear actuator.

In preferred embodiments, the linear actuator is a cylinder actuator comprising a piston and a barrel.

More preferably, the cylinder actuator comprises a hydraulic cylinder.

Preferably, the grapple assembly comprises means for connecting the cylinder actuator to a fluid pump.

Preferably, the means for connecting the first end of the elongate member to the grapple hoist comprises a rotatable connection means, wherein the grapple assembly can rotate relative to the hoisting means.

More preferably, the means for connecting the cylinder actuator to the fluid pump comprises one or more fluid conduits adapted to rotatably connect to one or more hoist fluid conduits such that the grapple assembly can rotate relative to the hoisting means.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a cross-sectional view illustration of a grapple assembly according to an embodiment of the invention;

FIG. 2 is another cross-sectional view illustration of the grapple assembly shown in FIG. 1;

FIG. 3 is a side view illustration of a grapple assembly according to another embodiment of the invention; and

FIGS. 4-6 are cross-sectional view illustrations of a grapple assembly according to another embodiment of the invention.

### DETAILED DESCRIPTION OF PREFERRED EMBODIMENTS OF THE INVENTION

### Grapple Assembly

### First Embodiment

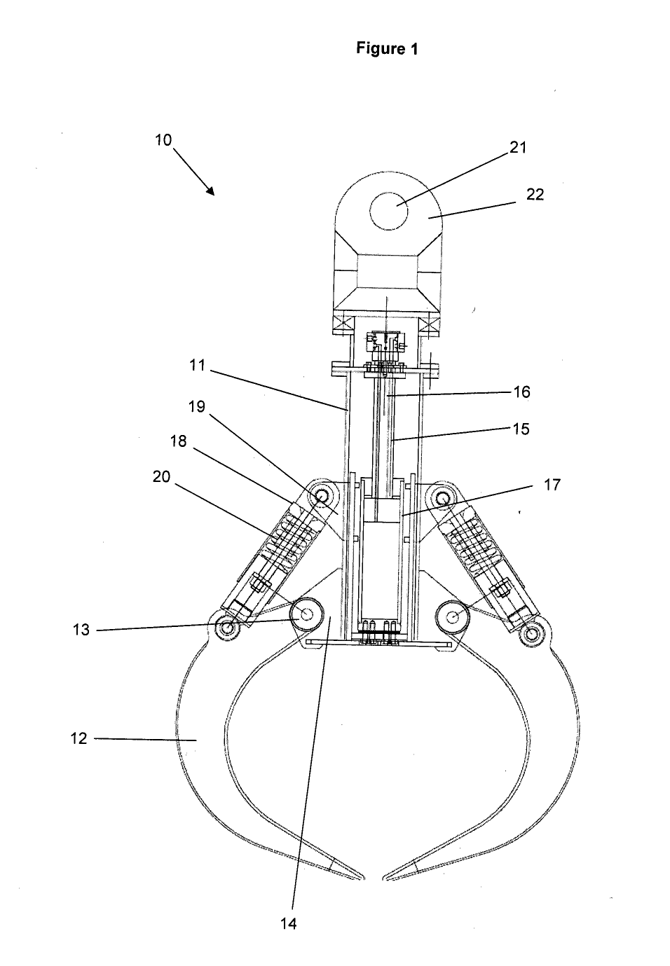

FIG. 1 is a cross-sectional view illustration of a grapple assembly 10 according to an embodiment of the invention. Grapple assembly 10 comprises an elongate core comprising an elongate member which, in the embodiment shown in FIG. 1, takes the form of a hollow cylinder 11 having a plurality of longitudinal channels in its outer elongate surface that open to the elongate cavity inside the cylinder 11.

Pivotally connected to a bottom end of the cylinder 11 (in the orientation of the grapple assembly shown in FIG. 1) are two or more grapple arms 12. Each grapple arm 12 is connected to the cylinder 11 by pivotal connections 13 which are oriented substantially perpendicularly to the cylinder 11 such that the grapple arms 12 each pivot in a plane generally parallel to the cylinder 11. In the embodiment shown, the grapple arms 12 are connected to the cylinder 11 by means of fins 14 extending outwards from the surface of the cylinder.

Grapple arms 12 may be inwardly curving, as shown in FIG. 1 and as is commonly known in the art. More generally, grapple arms may comprise hooks, claws, scoops or any other form of lever arm.

Additionally forming part of the elongate core and mounted inside cylinder 11 is a cylinder actuator which, in the embodiment of FIG. 1, is a hydraulic cylinder 15. The hydraulic cylinder 15 is able to extend longitudinally within the cavity inside cylinder 11. In FIG. 1, the piston 16 of the hydraulic cylinder 15 is connected to the upper end of the cylinder 11 with the barrel 17 of the hydraulic cylinder 15 extending downwards in the cavity. FIG. 1 shows the hydraulic cylinder 15 with the piston in an extended position.

Grapple assembly 11 further comprises a plurality of elastically deformable connectors in the form of connecting rods 18. Each of the rods 18 is pivotally coupled at one end to one of the grapple arms 12 at a point on the grapple arm that is spaced apart from the pivotal connection 13 of the respective grapple arm 12 to the cylinder 11. The rods 18 are each pivotally coupled at their other end to the barrel 17 of hydraulic cylinder 11 through one of the longitudinal channels in the surface of cylinder 11. The pivotal coupling of the rods 18 to the barrel 17 may be direct or indirect, for example one or more intermediate components may be used to facilitate the pivotal coupling. In the exemplary embodiment shown in FIG. 1, the rods 18 are each pivotally coupled to a fin 19 that is itself attached to barrel 17.

Rods 18 may comprise two sections able to move longitudinally relative to each other, the two sections interacting by means of a spring 20 such that longitudinal contraction of the rod 18 is resiliently opposed. In the embodiment shown in FIG. 1, one of the two rod sections comprises a shaft extending through a central hole of the other rod section, the shaft having a stop or bolt on its end to prevent the two rod sections disengaging. The spring 20 is mounted on the shaft.

FIG. 1 shows the grapple assembly in a closed configuration, with the tips of the grapple arms 12 in close proximity. Since the barrel 17 of the hydraulic cylinder 15 is at the bottom end of the cylinder 11, the configuration shown in FIG. 1 is a fully closed configuration, with the tips of the grapple arms 12 not able to move any closer together, apart from through extension of the springs 20 in the connecting rods.

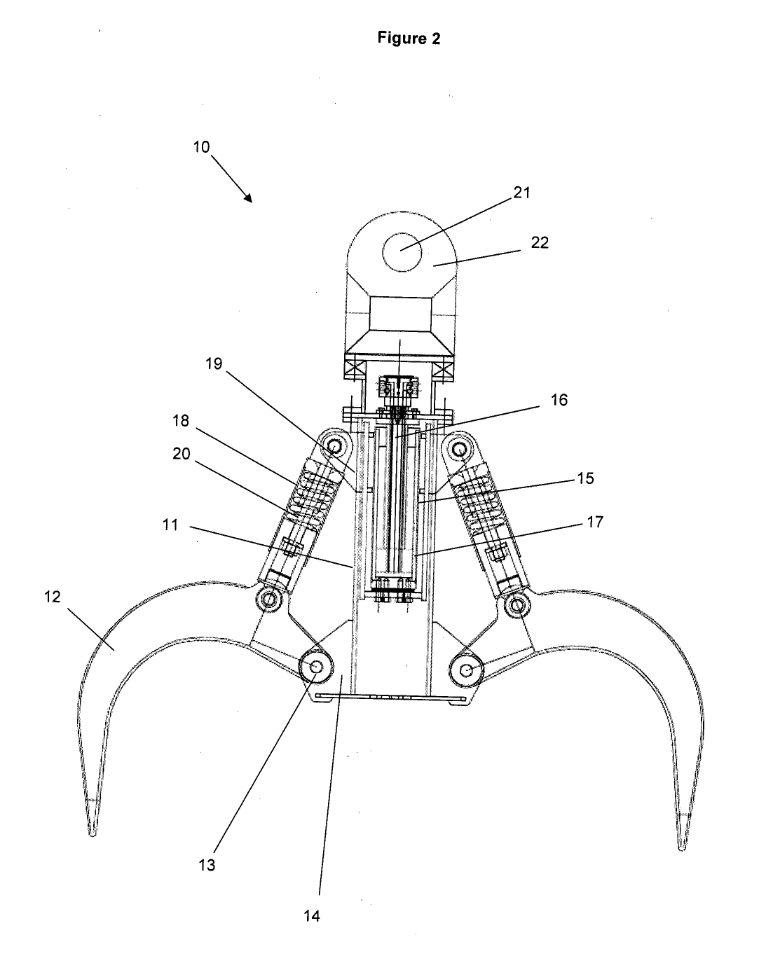

FIG. 2 is another cross-sectional view illustration of the grapple assembly 10 shown in FIG. 1. Like references are used to label like components. In FIG. 2, the grapple assembly is shown in an open configuration.

To move the grapple assembly 10 from the closed configuration shown in FIG. 1 to the open configuration shown in FIG. 2, the hydraulic cylinder 15 is contracted. The operation of hydraulic cylinders is well known in the art so possible ways in which this contraction can be effected will be apparent to the skilled addressee. Contracting hydraulic cylinder 15 causes barrel 17 to move upwards inside cylinder 11. Fins 19, which are attached to the barrel 17, also move upwards. This causes connecting rods 18 to pull the grapple arms 12 upwards, causing them to open. It will be apparent that the spacing between the points at which rods 18 connect to the grapple arms 12 and the pivotal connections 13 between the grapple arms 12 and the cylinder 11 allows the grapple arms to be lifted by means of a lever arm effect.

FIG. 2 illustrates the grapple assembly 10 in a fully open configuration, with the hydraulic cylinder 15 fully contracted. To close the grapple assembly, the hydraulic cylinder is actuated to extend, thereby reversing the motions discussed above. It will be evident that the extension of the hydraulic cylinder 15 may be controlled in a conventional manner to control the degree of opening of the grapple assembly 10.

It will be apparent that, while some embodiments of a grapple assembly according to the invention may be configured with the hydraulic cylinder 15 in the orientation shown in FIGS. 1 and 2, other embodiments may be configured with a hydraulic cylinder in an inverted orientation relative to FIGS. 1 and 2, that is, with the barrel connected to the upper end of the elongate cylinder and the piston extending downwards. In these embodiments, the connecting rods are connected to the piston. The operation of these different embodiments is generally the same.

Other embodiments may comprise an arrangement in which extension of a hydraulic cylinder causes the claws to open, i.e. operating the opposite way around to the embodiment shown in FIGS. 1 and 2. The embodiments of FIGS. 1 and 2, in which the grapple arms close when the hydraulic cylinder extends, may be desirable if the hydraulic cylinder produces a greater actuation force on its extension so that the greatest force is produced to close the grapple arms.

The grapple assembly 10 allows the grapple arms to be opened and closed by means of actuating a single hydraulic cylinder. This means the grapple assembly does not suffer from the problems of the prior art described above in which hydraulic cylinders connect the grapple arms to the central cylinder, which requires many hydraulic hoses to feed hydraulic fluid to the numerous hydraulic cylinders.

These prior art grapple assemblies allow the position of each grapple arm to be controlled independently because the hydraulic cylinders can be extended by differing amounts. This helps such grapple assemblies pick up unevenly or asymmetrically shaped objects or groups of objects. One grapple arm can close a small amount around a large part of an object while another grapple arm closes a larger amount around a smaller part of the object.

Similar functionality is provided by the connecting rods 18 in the embodiment of the invention shown in FIGS. 1 and 2. The springs 20 allow the rods 18 to differ in length if a force is exerted on the corresponding grapple arm 12, for example by a large part of an object withstanding further closure of that grapple arm. If the grapple assembly 10 is closing and one grapple arm 12 encounters a rigid object then the spring 20 in that grapple arm contracts while the hydraulic cylinder 11 continues to extend, causing the other grapple arms, which have not encountered a rigid object, to continue closing. Each grapple arm can therefore react to the shape of the object(s) being grabbed in a different way, i.e. by at least partly opening or closing independently of the other grapple arms.

Another advantage of the spring 20 in rods 18 is that they dampen any impact to the grapple arms 12. That is, they act as shock absorbers. Grapple arms are prone to impact on the ground, against vehicles or any object and such impacts can cause damage to the grapple arms or other components of the grapple assembly. Springs 20 allow the grapple arms to recoil following an impact, absorbing some of the impact energy and reducing the possibility of damage.

Grapple assembly 10 further comprises means for connecting the cylinder 11 to a grapple hoist. A grapple hoist may comprise any apparatus on which the grapple assembly 10 can be suspended. Typical examples include vehicles such as cranes, diggers, trucks or the like, and rigs or other structures able to support a grapple assembly. In the embodiment shown, the grapple assembly 10 is connected to the hoist by means of a hole 21 in a connecting member 22.

Connecting member 22 may be rotatably connected to cylinder 11 such that cylinder 11 is able to rotate about its axis relative to connecting member 22. Examples of suitable rotatable connections will be apparent to those skilled in the art. The orientation of the cylinder 11 relative to the connecting member 22 may be controlled by any appropriate control mechanism, allowing the position of the grapple arms 12 relative to an object to be grabbed to be controlled.

One or more fluid conduits allow hydraulic fluid to enter or exit the chambers in the hydraulic cylinder. The fluid conduits may be adapted to connect to corresponding fluid conduits in the grapple hoist by rotatable conduit connections that allow the cylinder 11 to rotate relative to the connecting member 22 without causing the hydraulic fluid conduits to tangle.

### Grapple Assembly

### Another Embodiment

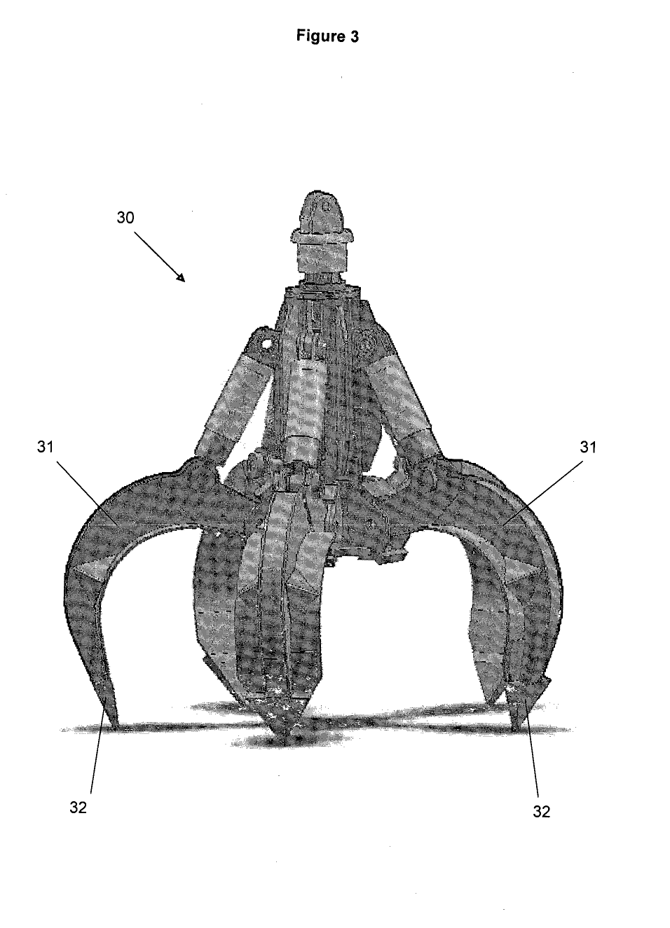

FIG. 3 is a side view illustration of a grapple assembly 30 according to another embodiment of the invention. The grapple assembly is shown in a partly open configuration in FIG. 3.

The grapple assembly 30 of FIG. 3 comprises five grapple arms 31 spaced equidistantly around the central axis of the grapple assembly. The tips 32 of the grapple arms may be able to be disconnected so that, if they get damaged, they can be easily replaced without necessitating replacement of a larger part of the grapple assembly.

### Alternative Embodiments of the Invention

In other embodiments of the invention, another type of cylinder actuator may be used. For example, the cylinder actuator may be pneumatically powered.

In other embodiments of the invention, the central component of the grapple assembly may comprise another form of linear actuator having a moveable member able to move longitudinally with respect to an elongate member, with the grapple arms connected via connecting rods to the moveable member. In some alternative embodiments, the moving part of the linear actuator may be mounted on the exterior of the elongate member, negating the need for the connecting rods to connect to the linear actuator through the elongate member, as may be the case in embodiments such as that shown in FIGS. 1 and 2 in which the linear actuator is a cylinder actuator mounted inside the elongate member. For example, in other embodiments, the linear actuator may be configured to move a ring-shaped element up and down a columnar elongate member, the connecting rods being pivotally coupled to the ring-shaped element.

Any suitable form of linear actuator may be used in which the moveable component to which the connecting rods are connected is able to move longitudinally relative to an elongate member. The invention is not limited by the selection of linear actuator. Furthermore, embodiments of the invention comprise any means for moving said component longitudinally relative to the elongate member and includes, for example, mechanisms providing said longitudinal movement by means of cables, chains or the like.

In other embodiments of the invention, other means may be provided to allow each grapple arm to open or close independently of the other grapple arms. The use of springs in the connecting rods as described above in relation to FIGS. 1-3 is one example of a way this can be effected. Any mechanism in which the grapple arms can each open or close if a force is exerted on them may be used. For example, embodiments of the invention include any mechanism by which the connecting rods may be able to contract or extend upon exertion of a force on the corresponding grapple arm. Damping mechanisms or resilient mechanisms able to oppose the contraction or extension of the connecting rod may be used in addition to, or as an alternative to, the springs discussed above, for example.

In some alternative embodiments of the invention, the grapple assembly comprises a power source to activate the grapple arms. That is, it is a self-powering assembly and does not connect to, for example, a hydraulic fluid source remote from the assembly.

In an alternative embodiment of the invention, the grapple assembly arms may comprise a linear actuator inside a central hollow elongate member such as a cylinder, with a moveable member able to move longitudinally inside the cylinder. The grapple arms of the grapple assembly are pivotally connected to the cylinder in a similar way to the embodiment shown in FIGS. 1 and 2 although the grapple arms in this embodiment have a cantilevered part extending from the pivotal connection into the cylinder. The cylinder has openings in its bottom end to receive the cantilevered parts of the grapple arms. Alternatively, the pivotal connections of the grapple arms are positioned below the bottom of the cylinder and the cantilevered parts extend below the cylinder into line with the cavity therein.

A plurality of elastic means, such as springs, connect the cantilevered part of each of the grapple arms with the moveable member of the linear actuator. While springs may be preferred in some embodiments, it will be evident that other elastically deformable means that are able to operate under both tension and compression can also be used.

When the linear actuator is actuated upwards, the springs stretch until they draw the cantilevered parts of the grapple arms upwards, thereby causing the grapple arms to close. When the linear actuator is actuated downwards, the springs compress until they push the cantilevered parts of the grapple arms downwards, thereby causing the grapple arms to open.

The springs allow each grapple arm to move to a certain extent independently of each other and thereby allow the grapple assembly to pick up unevenly shaped objects. At the same time, the springs allow each grapple arm to recoil on impact to the grapple arm and reduce damage to the grapple assembly as a result.

This embodiment may be more compact than the embodiments of FIGS. 1-3 because of the lack of connecting rods between the grapple arms and the actuator.

### Grapple Assembly

### Further Embodiment

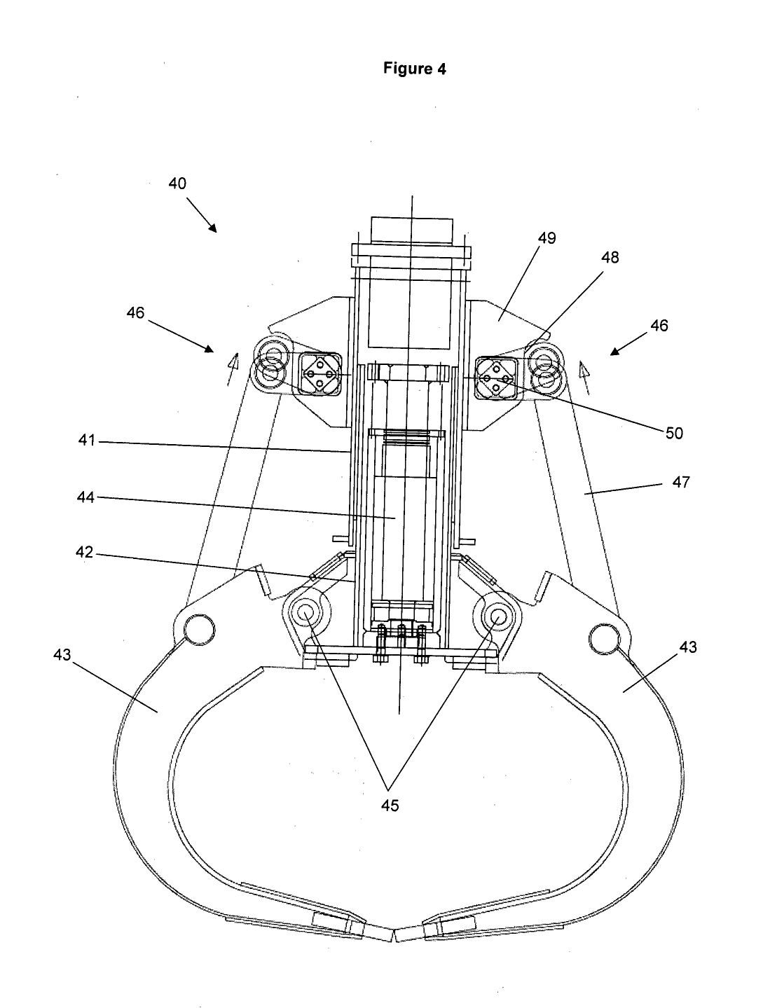

FIGS. 4, 5 and 6 are cross-sectional view illustrations of a grapple assembly 40 according to another embodiment of the invention. The grapple assembly in this embodiment of the invention shares many features in common with the grapple assembly of the embodiment of the invention shown in FIGS. 1 and 2, and only those features that differ from that embodiment will be explained in detail in the following.

In FIG. 4, the grapple assembly is in a closed configuration. Grapple assembly 40 comprises an elongate core which, in the embodiment shown in FIG. 4, comprises a first elongate member in the form of a first hollow cylinder 41 in telescoping relationship with a second elongate member in the form of a second hollow cylinder 42. A portion of the second hollow cylinder 42 extends out the bottom of the first hollow cylinder 41 in the closed configuration.

A linear actuator such as a hydraulic cylinder 44 is mounted inside, and attached to, the hollow cylinders such that the moveable member of the linear actuator (the barrel in the embodiment shown in FIG. 4) is attached to the second hollow cylinder 42 while a fixed part of the linear actuator (the piston in FIG. 4) is attached to the first hollow cylinder 41. Therefore, actuation of the actuator causes the second hollow cylinder 42 to move downwards out of the first hollow cylinder 41.

Two or more grapple arms 43 are pivotally connected to outside of the second hollow cylinder 42 using pivot connections 45 in a similar manner to the equivalent pivotal connections shown in FIGS. 1 and 2. Elastically deformable connectors 46 connect each grapple arm 43 with the outside of the first hollow cylinder 41 in a manner that allows causes the grapple arms 43 to open on actuation of the linear actuator 44 but allows each grapple arm to open and/or close at least partly independently of the other arms.

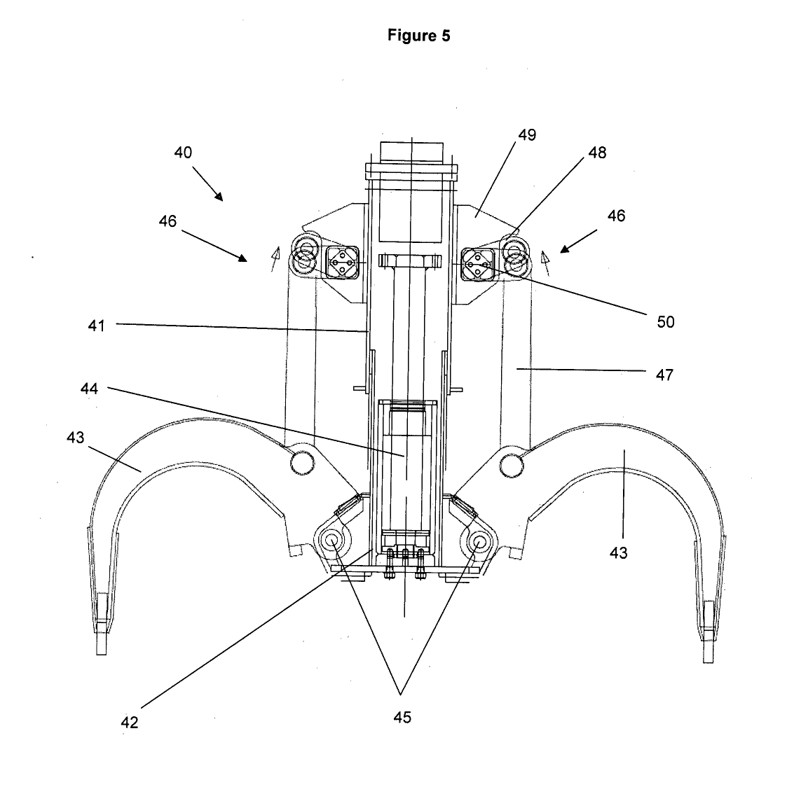

In the embodiment shown in FIGS. 4 and 5, connectors 46 comprise a first rod 47 connected at one end to a grapple arm 43 via a pivotal connection. The other end of first rod 47 is pivotally connected to one end of a second rod 48. The other end of the second rod 48 is pivotally connected to the outside of the first hollow cylinder 41, for example by means of a fin 49 extending from the outside of the cylinder. One of the pivotal connections, and in the embodiment of FIGS. 4 and 5 this is the pivotal connection between the second rod 48 and the fin 49, comprises a torsion spring that allows some rotational movement but only up to a load predetermined by the stiffness of the spring. In some embodiments, a rubber torsion spring 50 may be used.

FIG. 5 shows the grapple assembly in an open configuration. In operation, to move the assembly between the open and closed configurations of FIGS. 4 and 5, cylinder actuator 44 is extended (to open the grapple) and retracted (to close the grapple).

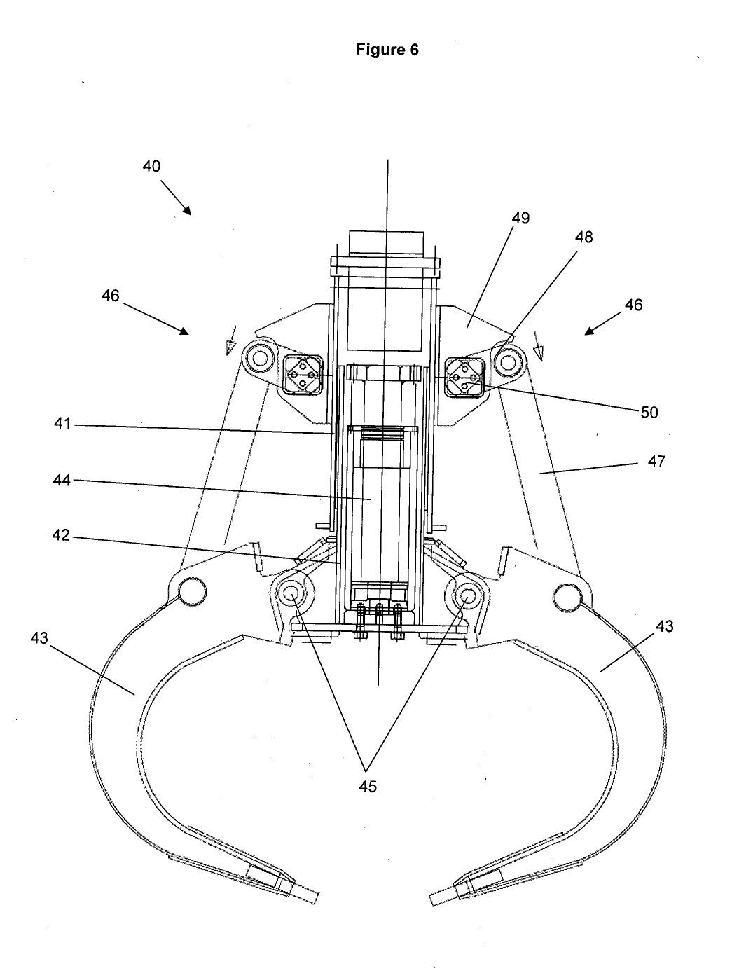

FIG. 6 shows the grapple assembly when an external opening force is applied to the grapple arms 43 when the assembly is in the closed configuration. Since the connectors 46 between the grapple arms 43 and the elongate core are elastically deformable, the arms can open without actuation of the cylinder. Furthermore, although not shown in FIG. 6, each of the grapple arms 43 can open independently of the other arms by an amount determined by the stiffness of the elastically deformable connectors 46.

One advantage of a rubber torsion spring 50 providing the elastic deformability of the connectors 46 is some types of rubber torsion spring exert a resistive force that increases non-linearly with the angular displacement, i.e. resistance increases with displacement to a greater degree than a normal spring that obeys Hooke's Law. This may be suitable in some uses.

In another embodiment of the invention, the elastic deformability of the connectors may be provided by a fluid compression cylinder. The fluid compression cylinder may use a fluid like oil or a gas like air as the absorption medium. Such a cylinder allows for some deformation of each grapple arm while restoring each arm to its ‘home’ position in a similar manner to a vehicle shock absorber.

In another embodiment of the invention, a grapple assembly may be provided similarly to that shown in FIGS. 4-6 but without the first and/or second hollow cylinders in which the other components of the assembly connect directly to the actuator rather than to components housing the actuator. This reduces componentry, although cylinders housing the actuator may help to reduce dust and other contaminants interfering with operation of the actuator.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A grapple assembly comprising:
an elongate core having a first end and a second end, and comprising a linear actuator;
a grapple hoist connector for connecting the first end of the elongate core to a grapple hoist;
a plurality of grapple arms, each grapple arm connected to the second end of the elongate core by a pivotal connection oriented substantially perpendicularly to the elongate core;
a plurality of elastically deformable connectors, each connector having a first end coupled directly or indirectly to a connection region of the elongate core, and a second end coupled to one of the grapple arms at a point on the respective grapple arm spaced apart from the pivotal connection of the respective grapple arm to the elongate core,
wherein the linear actuator is able to be actuated to move the connection region of the elongate core relative to the second end of the elongate core to open and/or close the plurality of grapple arms, and
wherein the elastically deformable connectors permit each grapple arm to at least partly open and/or close independently of the other grapple arms upon exertion of an external force on the respective grapple arm.

2. The grapple assembly as claimed in claim 1, wherein each elastically deformable connector is adapted to contract upon exertion of the force on the corresponding grapple arm.

3. The grapple assembly as claimed in claim 1, wherein each elastically deformable connector comprises a damper.

4. The grapple assembly as claimed in claim 1, wherein each connecting rod comprises one or more springs acting to oppose contraction of the connecting rod.

5. (canceled)

6. The grapple assembly as claimed in claim 1, wherein each elastically deformable connector comprises two rod sections engaged together and able to move longitudinally relative to each other, the two rod sections interacting by means of the one or more springs such that longitudinal contraction of the connector is resiliently opposed.

7. The grapple assembly as claimed in claim 1, wherein the elastically deformable connectors each comprise first and second rods having ends connected together by means of a torsion spring.

8. The grapple assembly as claimed in claim 1, wherein the first end of each elastically deformable connector is pivotally coupled to the connection region of the elongate core by means of a fin connected to the connection region.

9. The grapple assembly as claimed in claim 1, wherein each grapple arm is directly or indirectly connected to a moveable member of the linear actuator.

10. The grapple assembly as claimed in claim 9, wherein the first end of each elastically deformable connector is connected to a fixed part of the elongate core.

11. The grapple assembly as claimed in claim 9, wherein the elongate core comprises an first elongate member with an elongate cavity therein, the elongate cavity having an opening at the second end of the elongate core, the linear actuator is mounted inside the first elongate member with the moveable member thereof extending out of the opening at the second end of the first elongate member and able to move longitudinally with respect to the first elongate member.

12. The grapple assembly as claimed in claim 11, wherein the elongate core comprises a second elongate member in telescoping relationship with the first elongate member, the moveable member of the linear actuator being mounted inside the second elongate member and the plurality of grapple arms being connected to an outer portion of the second elongate member.

13. The grapple assembly as claimed in claim 1, wherein the first end of each elastically deformable connector is directly or indirectly connected to a moveable member of the linear actuator.

14. The grapple assembly as claimed in claim 13, wherein each grapple arm is connected to a fixed part of the elongate core.

15. The grapple assembly as claimed in claim 13, wherein the elongate core comprises an elongate member comprising an elongate cavity therein and a plurality of longitudinal channels between the cavity and an elongate outer surface, the linear actuator is mounted inside the elongate member and the moveable member thereof is able to move longitudinally therein, and the plurality of elastically deformable connectors are each coupled to the moveable member through one of the longitudinal channels of the elongate member.

16. The grapple assembly as claimed in claim 15, wherein each fin couples one of the elastically deformable connectors to the moveable member and extends through one of the longitudinal channels in the elongate member.

17. The grapple assembly as claimed in claim 1, wherein the moveable member of the linear actuator is mounted inside an elongate cavity in the elongate core and each grapple arm comprises a cantilevered end extending from the respective pivotal connection into or into line with the elongate cavity in the elongate core, and each elastically deformable connector connects the cantilevered part of one of the grapple arms with the moveable member of the linear actuator.

18. The grapple assembly as claimed in claim 1, wherein the linear actuator is a cylinder actuator comprising a piston and a barrel.

19. The grapple assembly as claimed in claim 18, wherein the cylinder actuator comprises a hydraulic cylinder.

20. (canceled)

21. The grapple assembly as claimed in claim 1, wherein the grapple hoist connector comprises a rotatable connector, wherein the grapple assembly can rotate relative to the grapple hoist.

22. The grapple assembly as claimed in claim 1, further comprising one or more fluid conduits adapted to rotatably connect to one or more hoist fluid conduits such that the grapple assembly can rotate relative to the grapple hoist.

23. (canceled)
